(19) United States
(12) Patent Application Publication
(10) Pub. No.: US 2025/0244990 A1
(43) Pub. Date: Jul. 31, 2025

(54) Method and System to Dynamically Perform Dependency Compliance and Remediation

(71) Applicant: Dell Products L.P., Round Rock, TX (US)

(72) Inventors: Ravishankar N, Bangalore (IN); Suman Lal Banik, Bangalore (IN); Shiva Prasad H N, Bangalore (IN); Sandeep Venkatesh Pai, Bangalore (IN)

(21) Appl. No.: 18/429,001

(22) Filed: Jan. 31, 2024

(51) Int. Cl. G06F 8/65; G06F 8/61

(52) U.S. Cl. CPC G06F 8/65; G06F 8/61

(57) ABSTRACT

Described herein are methods and a system that provide for dependency compliance of products, such as software application that run on devices of a data center. The products have lifecycle prerequisites that can include installation of products in devices, upgrading of products, and uninstallation of products in devices. Product metadata of the lifecycle prerequisites are defined and stored, and are used to provide a dependency matrix. The dependency matrix is dynamically updated as product metadata is received. Actions on the product are performed based on the dependency matrix.

### BACKGROUND OF THE INVENTION

### Field of the Invention

The present invention relates to performing dependency compliance of products or software applications running on devices of a data center.

### Description of the Related Art

In a customer data center, there exists multiple devices, such as storage servers. Such devices implement and include software applications. Software applications (applications) have a life cycle of installation, upgrading, uninstalling, etc. Application life cycle management can involve prerequisites. Prerequisite includes configuration of product (application), environment configurations of the devices hosting the products (applications), support configuration, internal/external dependencies with other products (applications), etc.

When performing a change on a cluster or group of devices (e.g., nodes in the cluster), there can be possible failure points. For example, if an update operation takes place on a cluster/group of eight nodes/devices, where the operation has a minimum of 15 prerequisites (e.g., connectivity (e.g., firewall, credentials, ports, etc.), dependency configuration (e.g., privileges, licenses, installation etc.), support configurations (e.g., platform model, OS version, firmware version, driver version, etc.). The number of possible failure points is eight times 15 or 120.

Currently, the design of products (applications) handles prerequisites via either reactive or a proactive approach. The reactive approach provides errors and resolutions as to operation triggers, or through user manuals. The proactive approach s statically configures prerequisites before the installation/operation is triggered. With application design communicating across multiple environment boundaries (internet, remote machine, local operating system, hardware layers etc.), failure points of each operation are high when prerequisites are not configured.

With the reactive approach in handling prerequisites, users/administrators of the data center have the onus to resolve problems through manual processes that can take a significant learning curve, and are prone to errors. Users/administrators need to identify correct user manuals. Users/administrators have to go through pages of documentation. Based on error messages, users/administrators figure out how to resolve failures. If prerequisites are missed, users/administrators may have to iteratively perform the operation, observe the failure pattern, and resolve the failures until all prerequisites are met. Such issues can lead to an increase of support tickets (request for information) to vendors.

With the proactive approach in handling prerequisites, problems also can occur. Prerequisite checks are static and bundled with the product (application). Changes to the prerequisite checks can result in a change to the product (application). As a static proactive approach builds dependency for every product (application) in its installation bundle, dependency logic would have to be repeated for each of the product team which introduces inefficiency.

There can be multiple scenarios where prerequisite checks can change over time after product (application) installation, such as at a customer site: An operation may have a temporary known issue, which may have been introduced by an external application, OS patches, updates, etc. which are added/removed when applicable. Furthermore, introduction of a security issue observed post release which may need a recommendation to upgrade dependent software modules to a newer version.

### SUMMARY OF THE INVENTION

A computer-implementable method, system and computer-readable storage medium for performing dependency compliance of products running on devices of a data center comprising defining and storing product metadata for lifecycle prerequisites of a product; providing a dependency matrix based on the product metadata; updating the dependency matrix as product metadata is received; and providing for actions on the product based on the dependency matrix.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 is a system as implemented in the present invention;

FIG. 3 is a generalized flowchart for updating metadata content in dependency policy management service;

FIG. 4 shows a generalized flowchart for performing prerequisite checks during a product (application) feature invocation; and

FIG. 5 is a generalized flowchart for performing dependency compliance of products or software applications running on devices of a data center.

### DETAILED DESCRIPTION

Implementations described herein provide for methods and systems to define and store product (application) metadata used for lifecycle prerequisites that can include installation in devices, upgrading, and uninstallation in devices. The product (application) metadata is made available on a service, such as a vendor cloud service. The product (application) metadata is used to provide dependency matrices for given vendor products (applications) installed at a customer data center.

Furthermore, implementations described herein provide for methods and systems to dynamically update dependency matrices for installed products (applications), and to avoid product (application) changes.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

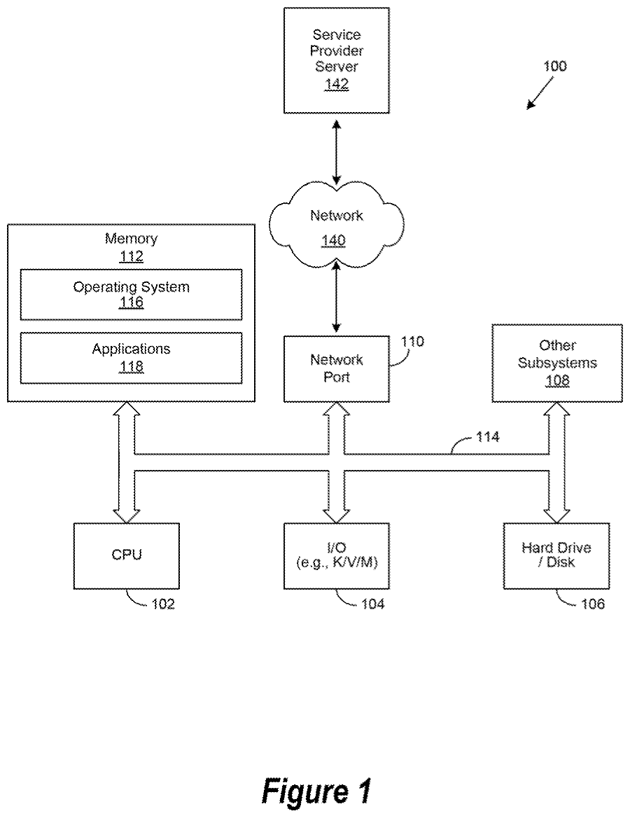

FIG. 1 is a generalized illustration of an information handling system (IHS) 100 that can be used to implement the system and method of the present invention. The information handling system (IHS) 100 includes a processor (e.g., central processor unit or “CPU”) 102, input/output (I/O) devices 104, such as a microphone, a keyboard, a video display or display device, a mouse, and associated controllers (e.g., K/V/M), a hard drive or disk storage 106, and various other subsystems 108.

In various embodiments, the information handling system (IHS) 100 also includes network port 110 operable to connect to a network 140, where network 140 can include one or more wired and wireless networks, including the Internet. Network 140 is likewise accessible by a service provider server 142.

The information handling system (IHS) 100 likewise includes system memory 112, which is interconnected to the foregoing via one or more buses 114. System memory 112 can be implemented as hardware, firmware, software, or a combination of such. System memory 112 further includes an operating system (OS) 116 and applications 118.

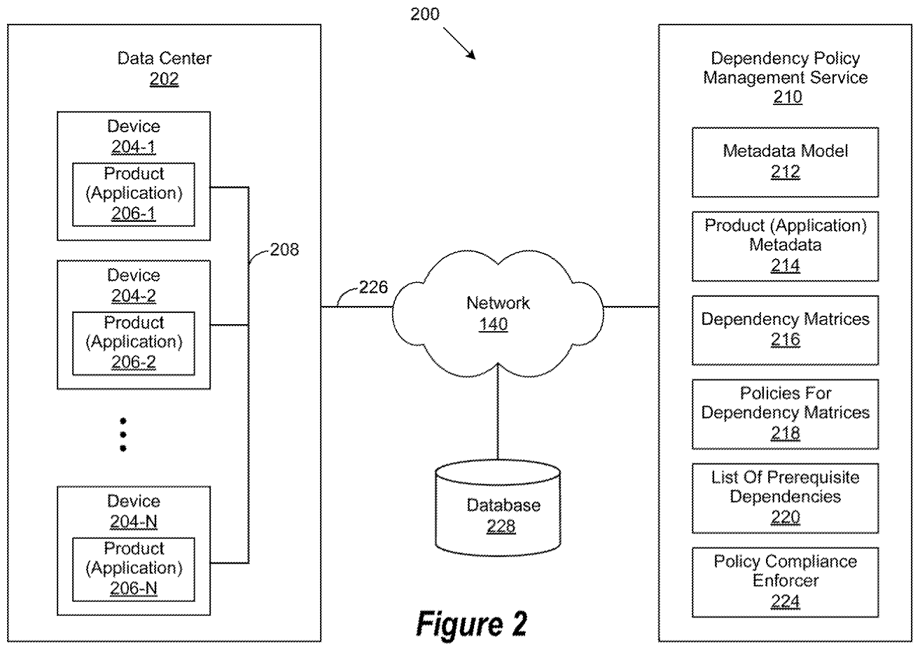

FIG. 2 shows a system 200 that supports the processes described herein. The system 200 includes a customer data center 202. The customer data center 202 can be located at one or more customer sites, and includes multiple devices 204-1 to 204-N. Examples of devices include edge devices, such as storage services. Embodiments provide for the devices 204 to include one or more product or software applications 206. The products (applications) 206 can be implemented as software modules. The products (applications) 206 may be provided and supported by various vendors. Implementations provide for the devices 204 and the products (applications) 206 to be interdependent and connected with one another. Particular interfaces 208 can be provided for such interdependency between the devices 204 and the products (applications) 206.

The products (applications) 206 have product lifecycle prerequisites that can include installation in devices 204, upgrading, and uninstallation in devices 204. The product lifecycle prerequisites can address software application dependency, which includes dependency between products (applications) 206 or software modules of the same vendor, and products (applications) 206 or software modules and external software module usage. The product lifecycle prerequisites can address configuration dependency, which includes system resource requirements and security requirements.

The products (applications) 206 can also have product feature prerequisites. The product lifecycle prerequisites can address configuration settings for a specific operation. The product lifecycle prerequisites can address installation of certain software module, where the software module performs a specific operation, which can be for the same product (application) 206 or another vendor product (application) 206.

Embodiments provide for the system 200 to include a dependency policy management service (DPMS) 210. Implementations provide for DPMS 210 to be a cloud based service or web based service. DPMS 210 can be hosted on a vendor service platform, where the vendor provides the devices 204 to the customer data center.

Implementations provide for the DPMS 210 to include or host a metadata model 212. The metadata model 212 will consume and process product (application) metadata 214 which is further described herein. The metadata model 212 uses dependency matrices 216 to create policies for dependency matrices 218 for every platform vendor product (application) 206 version. Implementations further provide for the metadata model 212 to maintain a consolidate list of prerequisite dependencies 220 for all the products (applications) 206, with associated versions a customer desires to deploy or use.

Implementations provide for the metadata model 212 to be saved either as a file or in a database (e.g., on DPMS 210). DPMS 210 can define data schema for the metadata model 212 used by products (applications) 206 to publish data. Implementations provide for the metadata model 212 to be constructed by aggregating published data from product teams for a given version of the product (application) 206.

The consolidate metadata model 212 can have dependency data for each of the products (applications) 206, and for each given version of the product (application) 206. An example format is as follows:

```
<DellProductDependencyMetaModel Version= [symbol] 1.0 [symbol] >
  <Product Id= [symbol] PROD-A [symbol]  Version= [symbol] 1.0 [symbol]  License= [symbol] Yes [symbol]  LicenseId= [symbol] ABCDEF [symbol] >
    <Features>
      <Feature Id= [symbol] Install [symbol]  PlatformOS= [symbol] Windows Server 2022 [symbol] >
        <Softwares>
          <Software>
            <Name>DSU</Name>
            <Version>2.0.2</Version>
            <Path>Systems-Management_Application_RWVV0_WN64_2.0.2.0_A00.EXE</Path>
            <PlatformOS>Windows Server 2022</PlatformOS>
            <Script></Script>
          </Software>
        </Softwares>
        <Configurations>
          <Configuration>
            <Name>BIOS</Name>
            <Version>2.0.2</Version>
            <PlatformOS>Windows Server 2022</PlatformOS>
            <Script></Script>
          </Configuration>
        </Configurations>
      </Feature>
      <Feature Id= [symbol] Provisioning [symbol]  Operation= [symbol] Update [symbol]  PlatformOS= [symbol] Windows Server 2022 [symbol] >
        <Softwares>
          <Script Command= [symbol] cmd.exe [symbol]  Path= [symbol] dsu.exe /u [symbol]  Arguments= [symbol] [symbol] />
        </Softwares>
      </Features
    </Features>
  </Product>
</DellProductDependencyMetaModel> [symbol]
indicates data missing or illegible when filed
```

Implementations provide for the DPMS 210 to include a module or component referred to a policy compliance enforcer 224. The policy compliance enforcer 224 resides on the DPMS 210, and includes logic to provides the following functions. The policy compliance enforcer 224 can implement a REST based interface, such as interfaces 226, to process a customer (i.e., customer data center 202) payload that can include product (application) identifier, product (application) product version, and feature identifier. The policy compliance enforcer 224 can parse metadata files based on a request from a customer (i.e., customer data center 202), form compliance data, and return the compliance data back to the product (application) 206. The policy compliance enforcer 224 can implement the REST based interface (API), such as interfaces 226, for a customer (i.e., customer data center 202) to push product (application) metadata 214, ensuring product (application) metadata 214 is created per specification. The policy compliance enforcer 224 can also create, update, or delete product (application) metadata 214 as a consolidated list. Restrictions can be provided as to permission to creating, updating, or deleting product (application) metadata 214.

For various implementations, system 200 further can include a store or database 228, which can store product (application) metadata 214, dependency matrices 216 to create policies for dependency matrices 218, consolidate list of prerequisite dependencies 220, and other data.

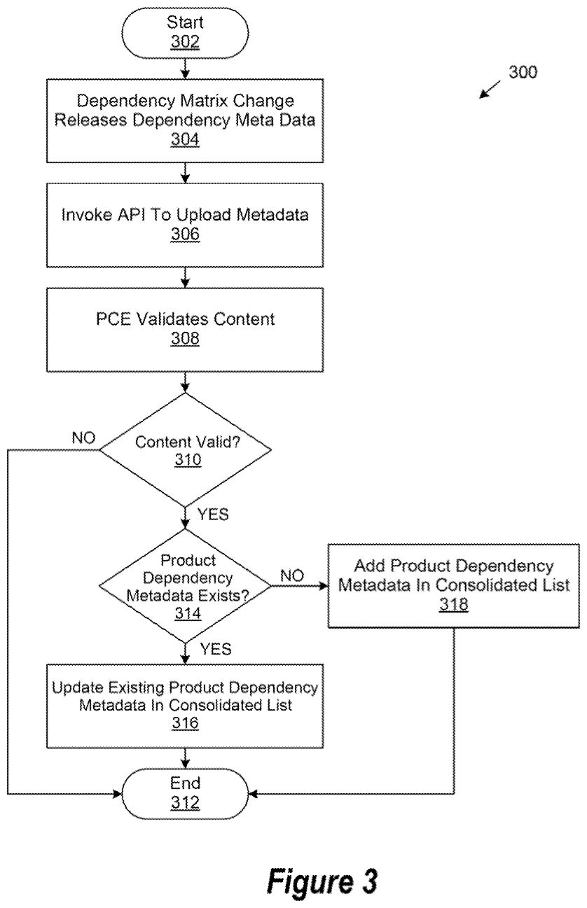

FIG. 3 shows a generalized flowchart for updating metadata content in dependency policy management service (DPMS) 210. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 302, the process 300 starts. At step 304, a change in a dependency matrix of a product (application) 206 results in a release of product (application) 206 dependency metadata. The release of product (application) 206 dependency metadata can also be the result of product (application) 206 releases.

At step 306, the DPMS 210, and particularly the policy compliance enforcer 224, invokes a REST based interface (API) to upload product (application) metadata 214. This can be invoked by an administrator of the DPMS 210.

At step 308, the policy compliance enforcer 224 validates the content product (application) metadata 214, ensuring that dependency metadata is created per specification for a given product (application) 206 and version, for all the features the product (application) 206 supports. Given certain prerequisites are dynamic in nature and can change over time for the same version of the product (application) 206, the dependency metadata can be updated dynamically as well without upgrading the product (application) 206. The product (application) 206 releases a new version of the dependency metadata.

If the content is not valid, following the “NO” branch of step 310, at step 312, the process 300 ends. If the content is valid, following the “YES” branch of step 310, if product dependency metadata exists, following the “YES” branch of step 314, at step 316, existing product dependency in the consolidated list is updated. At step 312, the process 300 ends.

If product dependency metadata does not exist, following the “NO” branch of step 314, at step 318 the product dependency metadata is added to the consolidated list. At step 312, the process 300 ends.

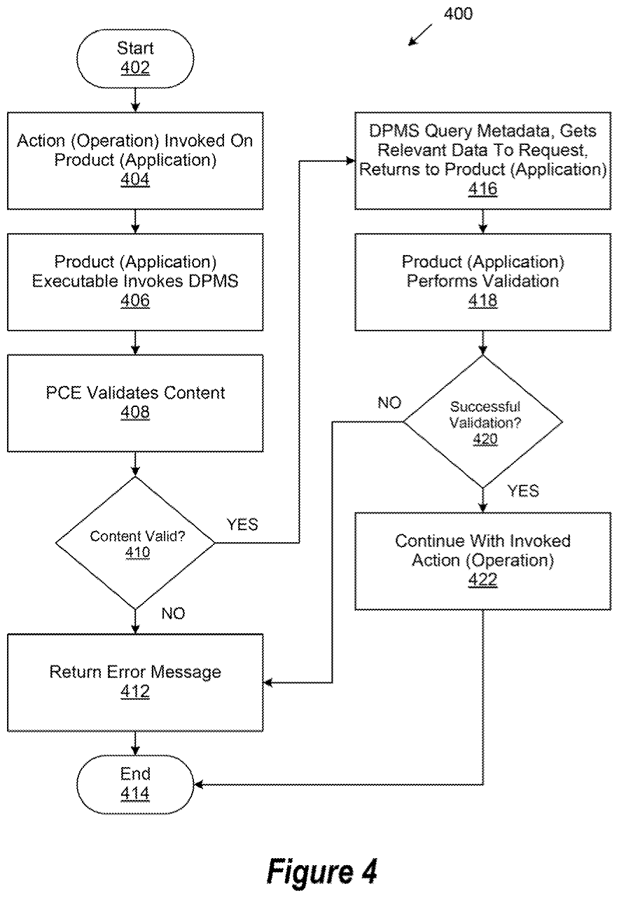

FIG. 4 shows a generalized flowchart for performing prerequisite checks during a product (application) feature invocation. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 402, the process 400 starts. At step 404, an action or operation on a product (application) 206 is invoked. Product (application) 206 actions or operations which can be lifecycle related or specific to a feature related invocation.

At step 406, product (application) 206 executable invokes DPMS 210. The invocation can be through a REST based interface (API), such as interfaces 226. A request is sent to the DPMS 210.

At step 408, DPMS 210, and particularly the policy compliance enforcer 224 validates the content of the request. If the content is not valid, following the “NO” branch of step 410, at step 412, an error message is returned to the product (application) 206 (i.e., device 204) or administrator of the data center 202. At step 414, the process 400 ends.

If the content is valid, following the “YES” branch of step 410, at step 416, DPMS 210 queries product (application) metadata 214, and gets the relevant data to the request which is returned to the product (application) 206, pulling dependency metadata and parsing content related to the request.

At step 418, product (application) 206 performs dependency validation. If dependency validation is not successful, following the “NO” branch of step 420, step 412 is performed. At step 414, the process 400 ends.

If dependency validation is successful, following the “YES” branch of step 420, at step 422 the invoked action (operation) is continued. At step 414, the process 400 ends.

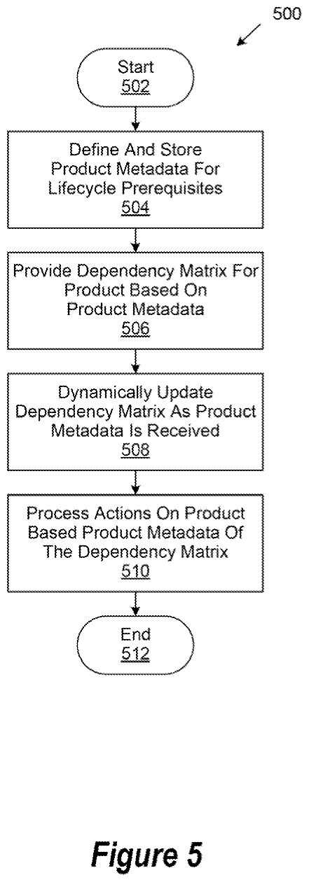

FIG. 5 shows a generalized flowchart for performing dependency compliance of products or software applications running on devices of a data center. In various implementations, the DPMS 210 performs the process 500. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 502, the process 500 starts. At step 504, product (application) metadata is defined and stored for lifecycle prerequisites of the product. At step 506, a dependency matrix is provided for the product (application) based on stored product (application) metadata. At step 508, the dependency matrix is updated dynamically as product (application) metadata is received. At step 510, actions on the product (application) are processed based on the dependency matrix and other data. At step 512, the process 500 ends.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for performing dependency compliance of products running on devices of a data center comprising:
defining and storing product metadata for lifecycle prerequisites of a product;
providing a dependency matrix based on the product metadata;
updating the dependency matrix as product metadata is received; and
providing for actions on the product based on the dependency matrix.

2. The computer-implementable method of claim 1, wherein the steps are performed on a cloud service or web service.

3. The computer-implementable method of claim 1, wherein lifecycle prerequisites include installation of products in devices, upgrading of products, and uninstallation of products in devices.

4. The computer-implementable method of claim 1, wherein the product metadata is parsed based on a request from the data center.

5. The computer-implementable method of claim 1, wherein a consolidated list includes product dependency data.

6. The computer-implementable method of claim 1 further comprising validating product metadata.

7. The computer-implementable method of claim 1 further comprising performing prerequisite checks during invocation of actions.

8. A system comprising:
a plurality of processing systems communicably coupled through a network, wherein the processing systems include non-transitory, computer-readable storage medium embodying computer program code interacting with a plurality of computer operations for performing dependency compliance of products running on devices of a data center comprising:
defining and storing product metadata for lifecycle prerequisites of a product;
providing a dependency matrix based on the product metadata;
updating the dependency matrix as product metadata is received; and
providing for actions on the product based on the dependency matrix.

9. The system of claim 8, wherein the steps are performed on a cloud service or web service.

10. The system of claim 8, wherein lifecycle prerequisites include installation of products in devices, upgrading of products, and uninstallation of products in devices.

11. The system of claim 8, wherein the product metadata is parsed based on a request from the data center.

12. The system of claim 8, wherein a consolidated list includes product dependency data.

13. The system of claim 8 further comprising validating product metadata.

14. The system of claim 8 further comprising performing prerequisite checks during invocation of actions.

15. A non-transitory, computer-readable storage medium embodying computer program code for performing dependency compliance of products running on devices of a data center, the computer program code comprising computer executable instructions configured for:
defining and storing product metadata for lifecycle prerequisites of a product;
providing a dependency matrix based on the product metadata;
updating the dependency matrix as product metadata is received; and
providing for actions on the product based on the dependency matrix.

16. The non-transitory, computer-readable storage medium of claim 15, wherein the steps are performed on a cloud service or web service.

17. The non-transitory, computer-readable storage medium of claim 15, wherein lifecycle prerequisites include installation of products in devices, upgrading of products, and uninstallation of products in devices.

18. The non-transitory, computer-readable storage medium of claim 15, wherein the product metadata is parsed based on a request from the data center.

19. The non-transitory, computer-readable storage medium of claim 15, wherein a consolidated list includes product dependency data.

20. The non-transitory, computer-readable storage medium of claim 15 further comprising performing prerequisite checks during invocation of actions.
